(19) United States
(12) Patent Application Publication
(10) Pub. No.: US 2010/0112180 A1
(43) Pub. Date: May 6, 2010

(54) WASHING, STERILIZING, DISPENSING AND CLOSING DEVICE FOR BABY BOTTLE AND ITS COMPONENTS

(76) Inventor: Amir Laniado, Gan Haim (IL)

Correspondence Address: EDWARD LANGER;c/o SHIBOLETH YISRAELI ROBERTS ZISMAN & CO., 1 PENN PLAZA-SUITE 2527, NEW YORK, NY, 10119, US

(21) Appl. No.: 12/594,218

(22) PCT Filed: Mar. 27, 2008
(86) PCT No.: PCT/IL08/00427

§ 371 Date: Oct. 1, 2009

Related U.S. Application Data
(60) Provisional application No. 60/907,443, filed on Apr. 2, 2007.
(60) Provisional application No. 60/946,412, filed on Jun. 27, 2007.

(51) Int. Cl. A23L 2/38; B65B 3/04; B65B 3/00; A47J 31/44

(52) U.S. Cl. 426/590; 141/91; 141/82; 141/100; 99/323.3

(57) ABSTRACT

The present invention provides a device for washing, sterilizing, dispensing metered doses of water and infant formula into, and closing baby bottles. A baby bottle includes a bottle body (124), a nipple (123), a nipple cap (122) and a bottle cap (121). The device is capable of automatically washing the baby bottle, nipple, nipple cap and bottle cap. The device also automatically sterilizes the bottle and its components, assembles the nipple, nipple cap and the bottle cap and dispenses water and metered doses of infant formula in the bottle. The device also automatically closes the baby bottle with the preassembled components, after filling it with the required amount of water and formula at the required temperature.

### FIELD OF THE INVENTION

The present invention relates to an automatic device for washing, sterilizing, dispensing metered doses of water and infant formula into a baby bottle body, and closing the baby bottle.

### BACKGROUND OF THE INVENTION

Heretofore, a baby bottle and its related components (the nipple, the nipple cap and the bottle cap) have been manually washed. Upon completion, a sterilizing process has to be applied to all the components. Upon completion, boiled water has to be prepared and poured into the bottle, which then has to cool until the required dose of infant formula can be added. It is then necessary to assemble the bottle and its apparatus before starting to feed the baby.

During the first year of life of a baby, a caregiver will have to treat baby bottles and their components approximately 2700 times. Treating the bottles and its components will include, in the first half a year, washing, sterilizing, boiling water, adding doses and assembling the bottle and its components. In the second half of the year there is no need for sterilizing and it can be omitted from the process.

During the first year of life that caregiver will have to prepare a baby bottle for feeding during the night time approximately 550 times. The night time feeding process is often executed by the caregiver holding the baby in its arms and with dimmed or no lighting. During the first year of life a caregiver will have to prepare a baby bottle for day time feeding approximately 2200 times. These activities are based on the assumption that the caregiver has previously cleaned and sterilized the bottles and their components.

The time it takes a caregiver to clean the bottles and their components, sterilize, prepare boiled water, fill up the bottle with the required doses and amount of water and eventually close the bottle and its parts, is approximately 30-45 minutes per day, which adds to approximately 240 hours in the first year. In the second year the time and effort needed is approximately half that of the first year.

Furthermore, the kitchen environment is affected by many different containers and devices needed by the caregiver to perform its bottle-related activities, such as lukewarm water container, hot water container, infant formula container, and sterilizer. In addition there are areas allocated to clean and/ or dirty bottles, and to their related components.

In view of the needs, many solutions have been proposed. Cleaning equipment of the kind divulged in U.S. Pat. No. 5,507,060 by Lester, and in U.S. Pat. Appl. No. US20030188769 by Avi Wisenberg, and in U.S. Pat. Appl. No. US20040123885 by Myong, and in U.K. Pat No. GB2,260,483 by Angelle Caresse, are not considered relevant since they are intended for cleaning baby bottles and their components only, without consideration of dispending liquid and metered doses of formula, and no attention to assembling the bottle and its components. Some solutions have been proposed as regards devices for dispensing liquid and powder. Equipment of the kind divulged in U.K. Pat. No. GB2,364,994 by Brian Jones, and in International Appl. No. WO03/084377 by Cheong, and in U.S. Pat. No. 6,829,431 by Ken Haven, and in U.S. Pat. No. US20020127005, are not considered relevant since they are intended for devices for preparing infant formula only.

None of the abovementioned inventions are related to a device that cleans, sterilizes, dispenses formula, and closes baby bottles and their components. In addition, none of the mechanical solutions that have been offered in the abovementioned patents is similar in any way to the present invention.

### SUMMARY OF THE INVENTION

One aspect of the present invention relates to a washing device for baby bottle body, nipple, nipple cap and baby bottle cap.

Another aspect of the present invention relates to a device for sterilizing the baby bottle body and its related components.

Another aspect of the present invention relates to a device or a mechanism to assemble a nipple, nipple cap and bottle cap.

Another aspect of the present invention relates to a device for dispensing a set amount of water that has been cooled to a set temperature in a baby bottle body.

Another aspect of the present invention relates to a device for dispensing a set amount of infant formula according to the requirements of the caregiver in a baby bottle body.

Another aspect of the present invention relates to a device for closing the bottle body with the assembled bottle components.

Another aspect of the present invention relates to a device that can contain up to three bottles concomitantly.

Another aspect of the present invention relates to a working concept and working method applicable to at least four bottles concomitantly, which is mechanically similar to the invention described in this application.

Another aspect of the present invention relates to a device whose main working space (i.e., working area number 1) is one open space under certain working conditions, and two or three separate spaces under different working conditions.

Another aspect of the present invention relates to a concept of sliding doors located on both sides of the washing section, thereby effectively sealing said washing section from the other sections and consequently separating the washing and sterilizing process from the other sections.

Another aspect of the present invention relates to a concept of a circular process that allows the bottle clips gripper to rotate by 180 degrees twice. During the first 180 degrees rotation the bottle body will rotate; together with the bottle clips gripper, from an upside down position to a position where its open side is facing upward. After the caretaker has taken the bottle, the bottle clips gripper will turn another 180 degrees, reaching to its original location in its original condition, thereby allowing the caretaker to insert another bottle (with its open side is facing down).

Another aspect of the present invention relates to a concept of assembling the bottle components, starting from the bottle cover, then the nipple cover and eventually the nipple itself.

### BRIEF DESCRIPTION OF THE DRAWINGS

FIG. 1 is a perspective view of the present invention.

FIG. 2 is a perspective view of the internal components of working area number 1 116 and working area number 2 117.

FIG. 3 is a perspective view of addition components related to working area number 1.

FIG. 4 is a perspective view of the core column, the bottles and their bases.

FIG. 4a is a sectional view taken along line G-G of FIG. 4.

FIG. 5 is a perspective view of the internal column of the core column. In addition FIG. 5 represents cut H-H, in the center of the internal column, representing the etchings in two halves of the column.

FIG. 5a is a sectional view of the internal column's etching, represented in relation to the location of the sections in working area number 1.

FIG. 6 is a perspective view of the internal column, the core column and two of three bottle bases arms. In addition FIG. 6 represents the location of the arm's pins inside the etching of the internal column.

FIG. 7 is a sectional and top view of the bottle body, bottle base and the arm that connects the bottle base to the internal and core column. The sectional and top view represents the position of the bottle in sections 2 and 3 (working area number 1).

FIG. 8 is a sectional and top view of the bottle body, bottle base and the arm that connects the bottle base to the internal and core column. The sectional and top view represents the position of the bottle in sections 1 (working area number 1).

FIG. 9 is a sectional view of the arm that connects the bottle base to the internal and core column. FIG. 9 relates to FIG. 8 position.

FIG. 10 is a top view of the arm that connects the bottle base to the internal and core column. FIG. 10 relates to FIG. 8 position.

FIG. 11 is a plan view of FIG. 7, where the view is from the internal column outside.

FIG. 11a is a plan view of FIG. 8, where the view is from the internal column outside.

FIG. 12 is a plan view of FIG. 7, where the view is outside in.

FIG. 13 is a sectional view of cut D-D of FIG. 3.

FIG. 14 is a sectional view of cut F-F of FIG. 3.

FIG. 15 is a plan view of the internal and core column, the arms that connect the bottle bases to the columns, and the two sliding doors.

FIG. 16 is a perspective view of the washing column, the washing arms and the bottle's components bases. FIG. 16 relates to FIG. 3.

FIG. 16a is a sectional view of cut B-B, FIG. 16, and C-C, FIG. 16a.

FIG. 17 is a perspective view of the sliding door, which represents the sliding door and its cover. Some of the internal mechanism is also shown. FIG. 17 relates to FIG. 3.

FIG. 17a is the same sliding door as in FIG. 17, shown without the door cover.

FIG. 18 is a perspective view of the sliding door mechanism. FIG. 18 relates to FIG. 17a.

FIG. 19 is a sectional view of the sliding doors. The drawing represents the doors in closed and open position.

FIG. 20 is a plan view of the mechanism of the sliding doors in both positions, open and closed. The figure represents cut A-A of FIG. 19.

FIG. 21 is a plan view of the sliding door in FIG. 19, where the view is inside-out.

FIG. 21a is a plan view of the sliding door in FIG. 19, where the view is outside-in.

FIG. 22 is a perspective view of the left front door, working area number 1.

FIG. 23 is a perspective view of the left front door, the washing column and its related components. It shows the location of the bottle components relative to the supporting plastics connected to the internal side of the door.

FIG. 24 is a plan back view of FIG. 22.

FIG. 25 is a perspective view of the telescopic arm 128 mechanism.

FIG. 26 is a front plan view of the telescopic arm 128 mechanism.

FIG. 27 is a plan side view of the telescopic arm mechanism.

FIG. 28 represents Cut M-M in FIG. 26.

FIG. 29 is a plan view of the gripper in two positions: closed and open.

FIG. 30 is a top plan view of cut N-N and Q-Q, FIG. 29.

FIG. 31 is a side view plan of the gripper in its closed position (FIG. 29).

### DETAILED DESCRIPTION OF THE INVENTION

This detailed description starts with a general description of the device.

### General Description

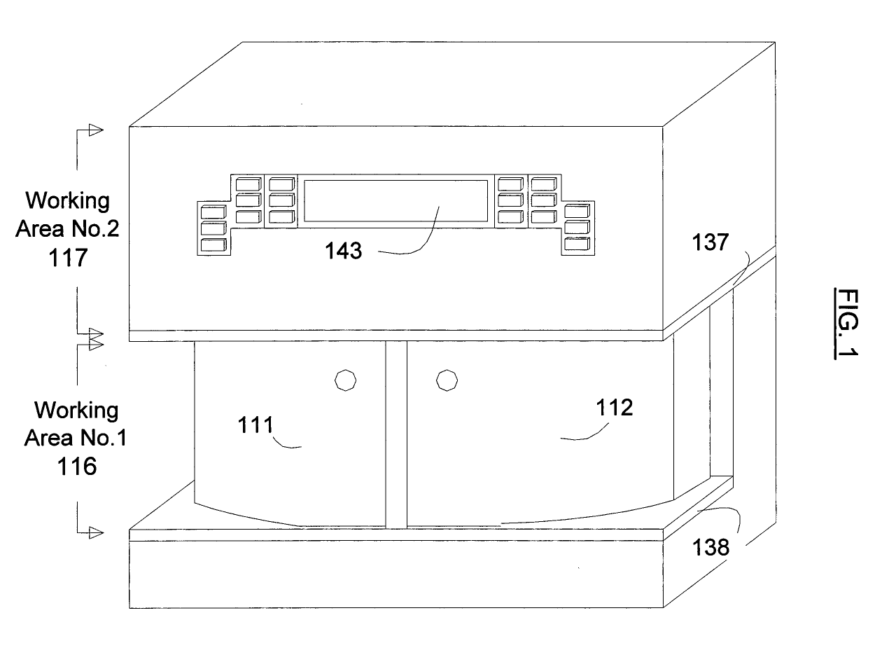

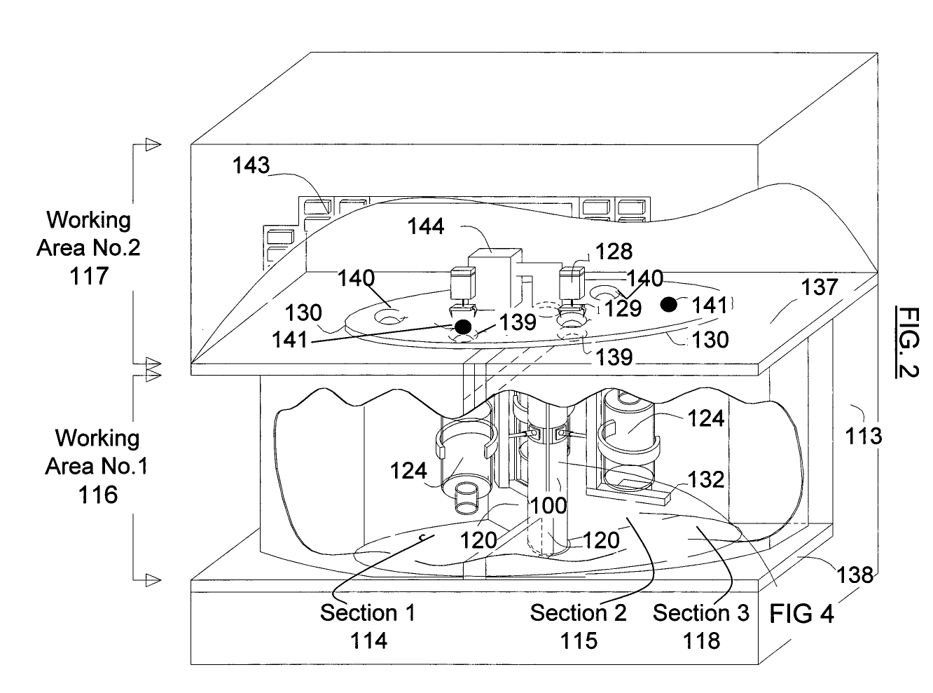

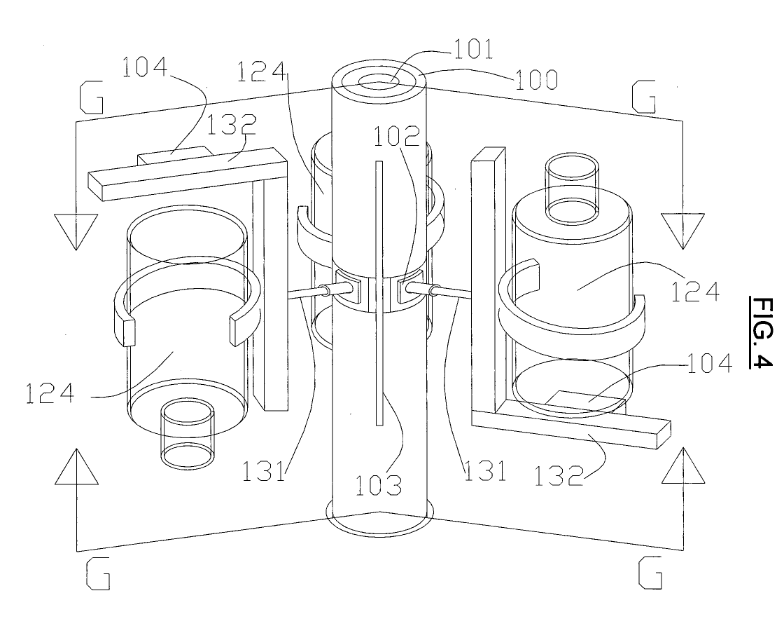

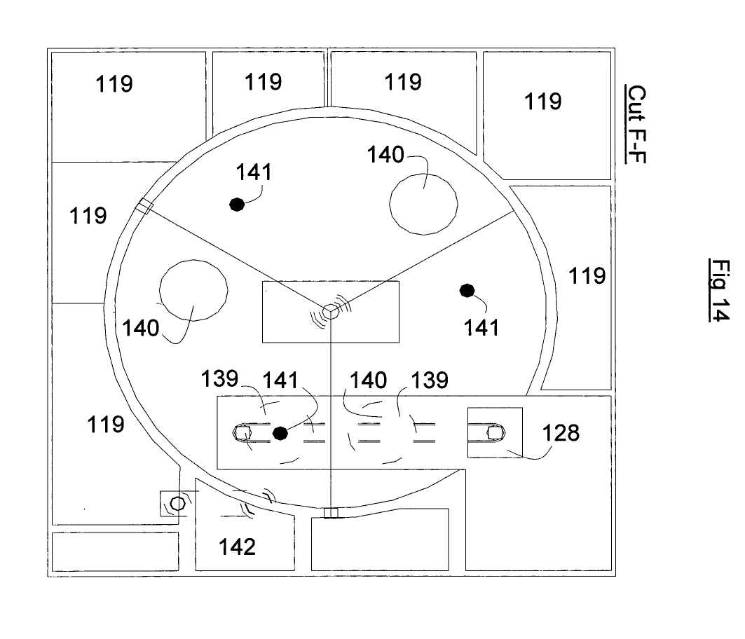

With reference to FIGS. 1, 2, 3, 13, 14, 15. The present invention is built of a core column 100, a front cover with two doors 111, 112 and a back and sides covers 113 which contain water tanks 119, dose tanks etc. The component in each one of the elements of the invention is described in detail further below. The space between the core column 100 and the covers is referred to as “working area number 1” 116, and will be considered as forming one, two or three sections or spaces according to the spatial position of the elements of the invention at a specific moment.

In the current document, and in order to best describe the invention, the inventor will consider working space number 1 116 as three separate spaces:
washing and sterilizing—section number 1 114,
waiting—section number 2 115,
filling and closing—section number 3 118,
   which connect together into one working area which has in its center a core column 100 and has around it two doors in the front 111, 112 and machinery and containers area in the back 119. In addition, on both sides of section number 1 114 there are two sliding doors 120 which seal the section during the cleaning and sterilizing process.

Above working area number 1 116, which is the horizontal level where the dirty bottle and its components are loaded, is located “working area number 2” 117. The upper level which is allocated to storing the nipple 123, nipple cap 122 and bottle cap 121, after they are assembled will be described in detail further below. In addition, working area number 2 117 also contains, in its free space, a storage area for water, and/or doses of infant formula or additives 119. It also contains engines and other elements which will be described further below.

### Method of Work

A typical working cycle with the present invention is described below.

The caretaker, after feeding the baby, takes apart the baby bottle body 124, nipple 123, nipple cap 122 and bottle cap 121, and inserts them in working area number 1, in the washing and sterilizing section 114, in their allocated places. The method of work and sequence of activities in the washing and sterilizing section will be described further below. The bottle is inserted with its open side facing down, and the bottle 124 components is inserted on three separate washing arms, one for each component 125, 126, 127. Upon completion of the cleaning and sterilization process, a gap opens between working area number 1 116 and working area number 2 117. A telescopic arm 128, with an attached gripper 129 then moves down from working area number 2 117 to working area number 1 116, to allow the gripper 129 to assemble the nipple 123, nipple cap 122 and bottle cap 121. After the bottle components has been assembled, the telescopic arm 128 and the gripper 129 holding the assembled components are transferred to working area number 2 117. The upper plate 130 then rotates approximately 60 degrees clockwise, allowing the gripper 129 to lay down the assembled components on the sealed area 141.

A full description of the washing, sterilizing, sealing and the way the nipple 123, nipple cap 122 and bottle cap 121 are assembled will be described further below.

When the gripper 129 has set the assembled components on the upper tray, the core column 100 turns towards section number 2 115, by moving approximately 120 degrees clockwise. The bottle, which is attached to the core column 100 by an arm 131, is by now in section 2 115. During the movement from section 1 to 2 the arm, which holds the bottle base 132, rotates by 180 degrees. The full description of the movement and the mechanism which allows a rotation of 180 degrees will be described in detail further below. The upper tray 130 in working area number 2 117, together with the assembled bottle components, also moves approximately 120 degrees together with the movement of the core column 100, allowing the assembled bottle components to follow the bottle 124 movement.

When section number 3 118 is empty, the core column 100 automatically rotates approximately 120 degrees clockwise allowing the bottle body 124 to move from section 2 115 to section 3 118. Together with the core column 100 movement the upper tray 130, which is located in working area number 2, also rotates approximately 120 degrees, allowing the bottle components to follow the bottle body. The present invention can contain three bottles concomitantly, one in each one of the three existing sections. When section number 3 118 is empty, i.e., after the caretaker takes out a bottle, the core column 100 automatically rotates approximately 120 degrees, allowing the bottle 124 from section 2 115 to reach section 3 118, together with its components located in working area number 2 117. At the same time the empty bottle base 132 (from which the bottle has been removed by the caretaker) moves from section 3 118 to section 1 114, allowing the caretaker to insert another set of dirty bottle components.

During the movement of the bottle base 132 from section 3 118 to section 1 114, the bottle base 132 rotates by 180 degrees, in order to allow it to reach section 1 114 in the same position as it was originally, i.e. allow the insertion of a dirty bottle with its open side facing down.

Once the caretaker sets the amount of infant formula or water to be dispensed, the gripper 129 in working area number 2 117, seizes the assembled components. In parallel, the required amount of water and formula is poured into the empty bottle. When the bottle body 124 has been filled with the required amount, the telescopic arm 128, the gripper 129 and the bottle components are lowered from working area number 2 117 to working area number 1 116, to be positioned above the bottle body. The telescopic arm 124 then rotates clockwise until the bottle body 124 and the bottle components are firmly attached one to the other and the bottle is ready to be taken by the caretaker. The telescopic arm 128, together with the empty gripper 129, now moves upward back to working area number 2. A signal indicating that the bottle is ready is then given to the caretaker, which is now able to open the door 112 to section number 3 118, take the bottle, shake it and feed the baby.

### Working Area No. 1-.Section 1: Washing and Sterilizing

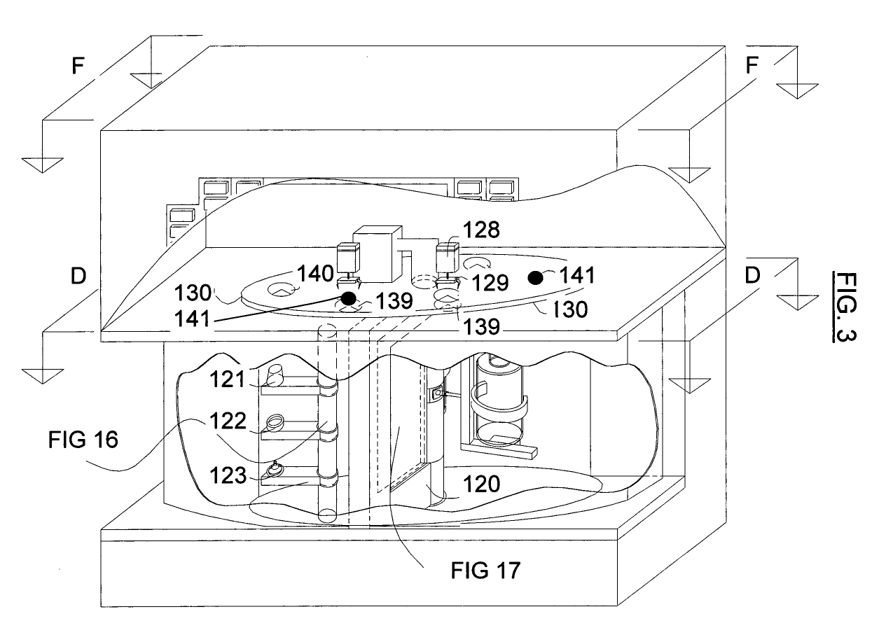

With reference to FIGS. 2, 3, 4, 16. A washing and sterilizing chamber, section 1 114 according to the present invention, is capable of accommodating baby bottle body 124, nipple 123, nipple cap 122 and bottle cap 121. The bottle 124 and its components are inserted in specific locations in the chamber. The bottle is inserted upside down, in the bottle base 132, while the nipple 123, nipple cap 122 and the bottle cap 121 are inserted in three silicon bases 133, 134, 135 which are located in three separate washing arms 125, 126, 127 that are supported by a washing column 136. The washing and sterilizing is done in three stages as follows: in the first stage water and soap are pressure-injected into nozzles located under the bottle body 124 and in the center of each one of the silicon bases 121, 122, 123. Additional nozzles are located on the washing column 136 and on the fixed parts of the sliding doors 120. These additional nozzles will be detailed further below. Additional nozzles are located on the fixed ceiling 137 and on the fixed floor 138 of section 1 114. The location of the nozzles is determined to allow full cleaning process of the inside and outside of the bottle body and all its components.

The second washing stage is the same as the first stage but without soap. Clean hot water is pressure-injected into the nozzles and directed towards the bottle body 124 and its components. In both the first and second cleaning stages the water temperature is approximately 80-90° C., to allow thorough cleaning of the bottle body and its components.

The third stage is sterilizing. During this stage water at 100° C. is pressure-injected through the nozzles to sterilize the area with the bottle and its components. Another option for sterilization is by ultrasonic or ultraviolet radiation emitted from an appropriate device which would be located in section 1 114.

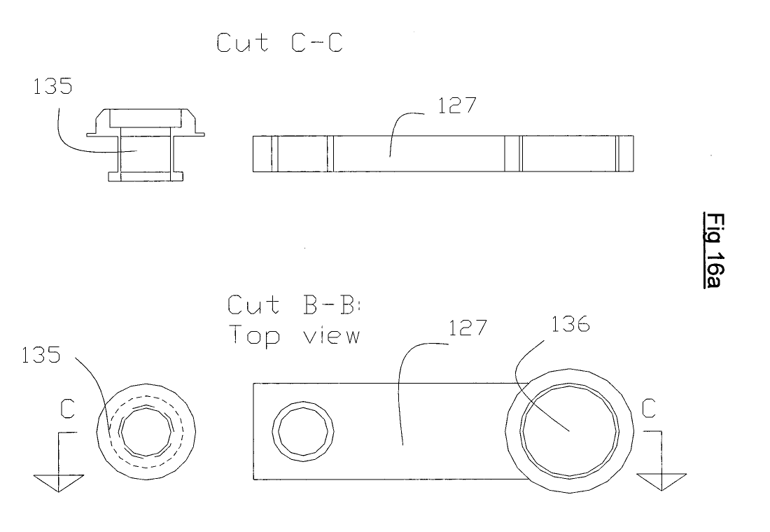

The silicon bases 133, 134, 135, upon which the components of the bottle components are placed, are fitted as shown in FIG. 16 into holes in the washing arms 125, 126, 127 which are connected to the washing column 136. This design allows the caretaker to change the silicon bases 133, 134, 135 according to the type of bottle 124 in use. In addition, the bottle base 132, which holds the bottle can also be changed and will be selected by the caretaker according to the type of bottle in use.

To avoid unwarranted movements of the bottle components during the pressure washes, the washing arms 125, 126, 127 connected to the washing column 136 will be located in the small gap next to the front door 111.

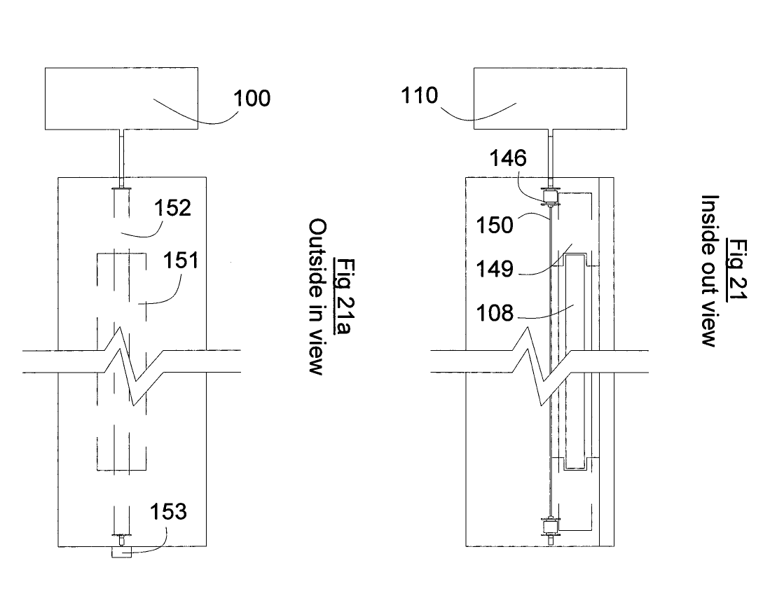

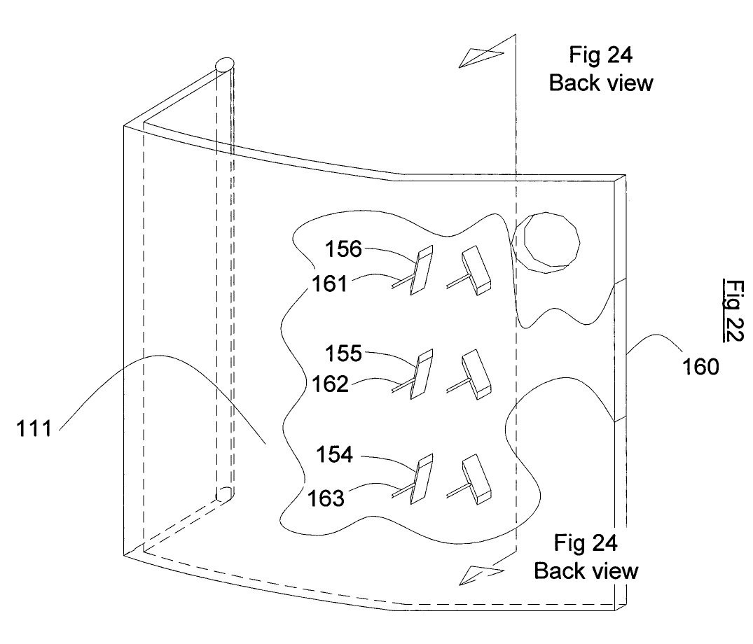

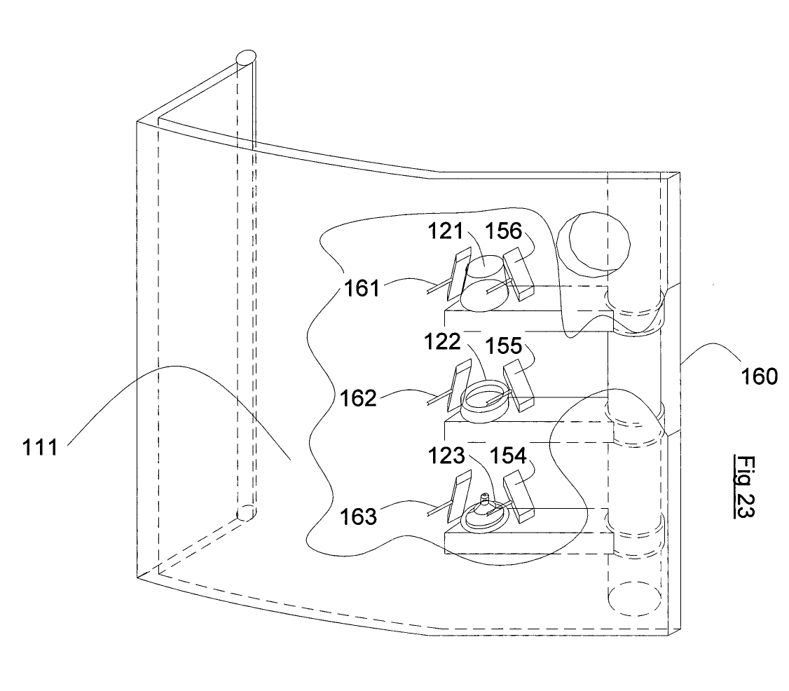

The left front door 111, which is made of a transparent material, has three sets of supporting plastics 154, 155, 156 in FIG. 22. The caretaker can adjust the angle of each set, as shown in the arrows 157, 158, 159, in FIG. 24, to the angle that maximizes the stability of the element of the bottle components FIG. 23 121, 122, 123, during the washing and sterilizing stages. The left door 111 cannot close, unless the plastic supports FIG. 22 154, 155, 156 are correctly placed and support the bottle components FIG. 23 121, 122, 123 from above.

The three sets of supporting plastics 154, 155, 156 are connected to the internal part of the left front door 160 via hinges 161, 162, 163, in order to allow the caretaker to change their angles easily.

### Working Area Number 1-Section 1: Sealing the Section.

With reference to FIGS. 1, 2, 13, 14, 19. Section number 1 114, in working area number 1 116, should be sealed before and during the washing and sterilization process. The section will be sealed in the front, back, two sides and from the ceiling in order to avoid spilling of water and soap. There is no need for sealing the floor 138 of the section due to the fact that under section number 1 114 there is a drain pool for easy draining of washing liquid. The floor 138 in section 1 114 is slightly inclined to set the direction to the drain pool.

The front of section number 1 114 is sealed by the front door 111, which will have to be locked after the caretaker has positioned the bottle 124 and its components 121, 122, 123 in their places.

The back side of section number 1 is sealed by the core column 100.

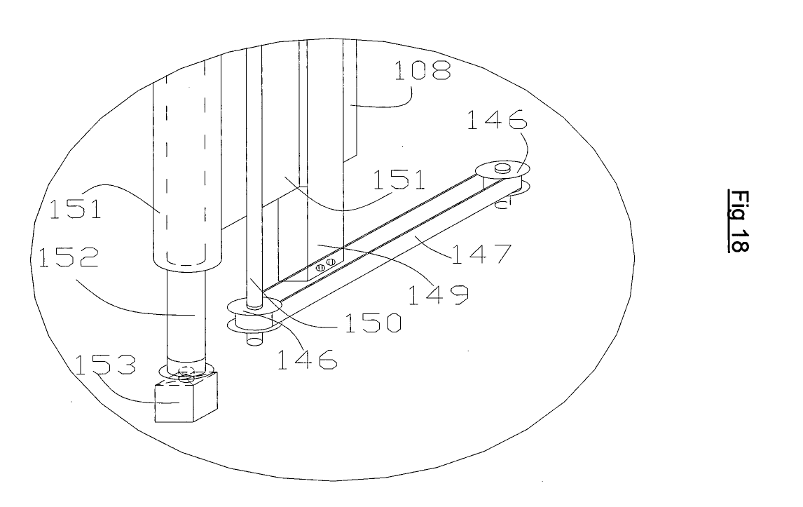

The two sides of section number 1 are sealed by two sliding doors 120, one on each side. The doors, when closed (FIG. 19) reach the core column 100 and allow water drainage to drain downward. When the sliding doors are open (FIG. 19), there is enough space for the bottle base 132 and a bottle 124 to pass from one section to the other. The full description of the sliding doors is given in detail further below.

Before explaining how the ceiling of section 1 137 is sealed, it is necessary to make clear that the ceiling of section 1 is fixed and connected to the top of each sliding door 120. In addition, the top part of the core column 100 is fixed and does not turn around with the bottom part. The hole 139 in the fixed ceiling 137 above section number 1 114 is the hole that allows the gripper 129 and its arm 128 to move from working area 2 117 to working area 1 116. The upper tray 130 which is located in working area number 2 117 is a few millimeters up from the fixed ceiling 137 of working area number 1 116. In addition, the upper tray 130 has three holes 140 and three sealed spaces 141 in order to allow the assembled components to be laid down and move clockwise together with the upper tray 130 and the bottle body 124, which is located in working area number 1 116.

During the washing and sterilizing process, the sealed area 141 in the upper tray 130 is above the hole 139 in the fixed ceiling 137 of section number 1 114. In addition there are silicon strips, or some flexible plastic strips, between the fixed ceiling 137 and the upper plate 130, which create a sealed area and avoid water or moisture leaving section number 1 114 from the fixed ceiling 137.

### Working Area Number 1-Section 1: Washing Column

With reference to FIGS. 2, 3, 14, 16. The washing column 136 supports three washing arms 125, 126, 127. The upper washing arm 127 is intended for the bottle cap 121, the middle washing arm 126 for the nipple cap 122 and the lower washing arm 125 for the nipple 123. Each arm has a hole next to its edge FIG. 16, to which the caretaker fits a silicon base 133, 134, 135 that suits the type of bottle components in use. In addition, in the hole of each washing arm 125, 126, 127, there is a nozzle for cleaning the inside of each component. The nozzle head is replaceable as well. The water pipes to the nozzles lead from inside, or outside, of the washing column 136.

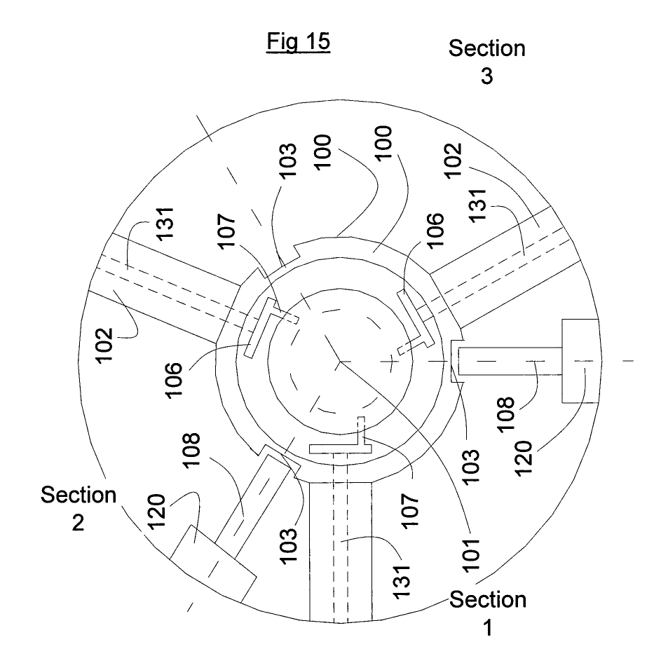

The washing column 136 is connected to an engine or sensor FIG. 14 142 that allows the washing column 136, the washing arm and the bottle components 121, 122, 123 to move approximately 80 degrees clockwise in order to allow the bottle to move to a position where they are beneath the gripper 129, and the hole 139 in the top fixed ceiling 137. During the process of assembling the bottle components, the washing column 136 and the washing arms 125, 126, 127 move from their original position, (which is where the bottle components elements are very close to the front door and located under the plastic sets that support the components in the washing process), to a position where the components elements are located under the gripper 129 and the hole 139 in the fixed ceiling 130 and back to their original position. This movement, backward and forward, i.e. ±80 degrees occurs 3 times and is part of the process of assembling the bottle components. A full explanation of the movements of the washing column, the washing arms and the bottle components will be given in detail further below.

### Working Area Number 1-Section 1: Assembling the Bottle Components.

With reference to FIGS. 1, 2, 3, 1, 16. When the washing and sterilization is over the bottle components elements are located next to the front door 111. The section ceiling 137 is sealed by the upper tray 130. The process of assembling the bottle components is as follows:

The upper tray 130, in working area number 2 117 rotates 60 degrees anticlockwise, which causes one of the holes 140 in the upper tray 130 to be above the hole 139 in the fixed ceiling 137. The washing column 136 then rotates 80 degrees clockwise, which places the washings arms 125, 126, 127 and the bottle components elements 121, 122, 123 under the hole 139 in the ceiling and under the gripper 129 and the hole 140 in the upper tray 130. The gripper then moves to working area 1 116 and grabs the bottle cap 121. A full explanation of the gripper and its telescopic arm will be given further below. After grabbing the bottle cap 121, the gripper moves upward, pulling the bottle cap 121 from its silicon base 135. The washing column 136 then moves 80 degrees anticlockwise. The gripper 129 then moves downward to a position where it is placed below the washing arm 127 of the bottle cap, and on top of the nipple cap 122. The washing column then moves 80 degrees clockwise to a position where the nipple cap 122 and the nipple 123 are below the gripper 129, which is still holding the bottle cap 121. The washing arm 127 of the bottle cap moves with the washing column 136 but is stopped by the telescopic arm 128 after a turn of approximately 60 degrees, and does not allow it to progress with the washing column 136 and the other two other washing arms 125, 126. Upon completion, the gripper 129, and the bottle cap 121, are lowered down to a position where the nipple cap 122 is firmly attached to the bottle cap 121. The telescopic arm 128 then takes the gripper 129 up, the bottle cap 121 and the nipple cap 122, until the nipple cap 122 is released from its silicon base 134. The washing column 136 then moves 80 degrees anticlockwise to its original position. Now the only component that remains on its base is the nipple 123. The telescopic arm 128 now lowers the gripper 129, holding the two assembled caps 121, 122 where it is placed below the nipple cap washing arm 126, and on top of the nipple 123. The washing column 136 then moves 80 degrees clockwise to bring the nipple 123 under the gripper 129 and the assembled components. The two washing arms of the bottle cap 127 and the nipple cap 126 are stopped by the telescopic arm 128 after a turn of approximately 60 degrees, not being allowed an 80 degrees turn. The telescopic arm 128 then lowers the gripper 129 until the nipple 123 is firmly attached to the nipple cap 122. Upon completion of the assembly of the bottle components, the telescopic arm 128 pulls up the gripper with the attached components, releasing the nipple from its silicon base 133. The washing column 136 then moves 80 degrees anticlockwise, to its original position, ready to be reloaded. The telescopic arm 128 then moves the gripper with the assembled components from the first working area 116 to the second working area 117. Upon completion, the upper tray 130, which before moved approximately 60 degrees anticlockwise to allow the gripper 129 to move from working area 2 117 to working area 1 116, will now move 60 degrees clockwise to a position where the sealed area 141 is below the gripper. The gripper 129 then releases the bottle components on the upper tray 130, ready to follow the bottle body movement, which will be to the second section 115 in working area number 1 116. The full description of the gripper and the telescopic arm will be given further below.

Working Area Number 1-section 1: Summary.

With reference to FIGS. 1, 2, 4, 6. The cycle starts in Section 1 114 with an empty bottle base 132, a washing column 136 and washing arms 125, 126, 127 ready to be loaded. After the caretaker loads the bottle body and its components, and presses the control panel 143 to start the cleaning, sterilizing and the building up process, the device washes and sterilizes the bottle body 124 and its components 121, 122, 123. Upon completion the invention automatically assembles the bottle components and deposits it on the upper tray 130 in working area 2 117. The sliding doors 120 then open and the core column 100 and the upper tray 130 rotate by approximately 120 degrees clockwise, allowing the bottle 124 and its assembled components to move to section 2 115, which is in a position of waiting until section number 3 118 is empty. In case section 3 118 has a bottle in it and section 1 114 has finished its work, the core column 100 will not move. Only after section 3 118 is emptied there will be movement of the bottle and its components 121, 122, 123 from section 2 115 to section 3 118 and from section 1 114 to section 2 115. The empty bottle base 132 in section 3 118 will move to section 1 114 ready to be reloaded.

### Working Area Number 1-Section 2: General

With reference to FIGS. 2, 4. In section 1 114 the bottle body 124 is upside down, with its open side facing down. During the movement of the bottle 114, the bottle base 132 and the core column 100 from section 1 to section 2, the bottle base 132 performs a 180 degrees turn around its axis, causing the bottle body 124 to reverse to an upright position, meaning that the bottle body leaves section number 1 114 with open side facing down and reaching section number 2 115 with open side facing up.

Section number 2 115, as described before, is a waiting area where an empty bottle, open side facing up, and its related components 121, 122, 123, that has been assembled and waiting in working area number 2 117, are waiting for section number 3 118 to be cleared. The moment area number 3 118 has been cleared, both the core column 100 and the upper tray 130 rotate approximately 120 degrees clockwise and transfer the bottle body 124 and its components 121, 122, 123 in section number 3 118. The empty bottle base 132 that was in section 3 118, then moves back to section 1 114 waiting to be reloaded.

During the movement of the bottle base 132 from section 3 118 to section 1 114, the bottle base 132 performs an 180 degrees rotation around its axis, in order for the bottle base to reach section 1 114 in a position where it is possible to insert a new bottle body with its open side facing down, i.e. the bottle base 132 reaches section 1 114 in its original state. How the bottle base 132 performs the 180 degrees rotation is described in detail further below.

### Working Area Number 1-Section 3: General

With reference to FIGS. 1, 2, 16. Section number 3 118 has two purposes. The first is to fill the bottle body 124 with water and infant formula, and the second is to close the bottle body 124 with its assembled components 121, 122, 123. Upon completion, the caretaker will open the second front door 112, take the full, closed bottle, mix it and feed the baby. After the caretaker retrieves the bottle and closes the front door 112, the core column 100 rotates approximately 120 degrees clockwise, and the bottle base 132 moves back from section 3 118 to its original position in section 1 114. During the movement of the clips gripper from section 3 118 to section 1 114, the bottle base 132 rotate 180 degrees around its axis, allowing re-loading of a new bottle with the open side facing downward. The new bottle is reloaded as described previously, in section 1 114.

The caretaker must give an order for the start of the process of filling and closing the bottle to occur. The bottle body 124 wait in section 3 118 with its open side facing up and the bottle body 124 is empty. The assembled components 121, 122, 123 will be waiting as well on the upper tray 130.

### Working Area Number 1-Section 3: Dispensing Water and Infant Formula

When the caretaker wishes to retrieve a bottle 124, he taps his request on the control board FIG. 1: 143. Water and the required amount of infant formula is then poured in the bottle. The full description of the water and doses mechanism will be given in detail further below.

### Working Area Number 1-Section 3: Closing the Bottle

With reference to FIGS. 1, 2, 4, 13, 14. After the bottle 124 has been filled up with the required amount of water and infant formula, the process of closing the bottle starts.

Before explaining the process of closing the bottle, the current position of the bottle body 124, the gripper and the bottle components 121, 122, 123, that has been assembled in section 1 114 will be clarified.

The bottle body 124 is located below the gripper. The ceiling 137 of the section 3 118 is sealed and has one hole 139, located above the bottle 124, allowing the gripper 129 to move from working area 2 117 to working area 1 116. Above the top fixed ceiling 137 is the upper tray 130, which has a hole 140 and a sealed area 141, on which the assembled bottle components 121, 122, 123 is resting.

The location of the bottle components 121, 122, 123 relative to the bottle body 124, if one considers the core column 100 as the center of a circle, is approximately 60 degrees, i.e. 60 degrees anticlockwise. And the open hole 140 in the upper tray 130 is located above the hole 139 in the top fixed ceiling 137 and above the bottle body 124.

The process of building the baby bottle 124 starts with a request by the caretaker and proceeds in parallel with the filling of the water and the infant formula in the bottle body. On request the upper tray 130 rotates approximately 60 degrees clockwise, placing the bottle components 121, 122, 123 below the gripper 129 and above the bottle body 124. The gripper 129 is then moved by the telescopic arm 128 until the gripper 129 grabs the bottle components 121, 122, 123. The telescopic arm 128 then lifts the gripper 129 and the components and the upper tray 130 rotates approximately 60 degrees anticlockwise, placing the hole 140 in the upper tray 130 below the gripper 139 and creating an open space between working area number 2 117 and working area number 1 116. When the bottle body has been filled with water and infant formula, the telescopic arm 128 lowers the gripper 129 and the components 121, 122, 123, until they are on top of the bottle body 124. The telescopic arm 128, and/or the gripper 129, then rotate clockwise until the bottle is closed. The gripper 129 then opens, and the telescopic arm 128 lifts the gripper without the bottle components, which is now attached to the bottle body. When the gripper 129 reaches its original position, the caretaker receives a notice that the bottle is ready to be taken. The caretaker will now be able to open the second front door 112 and take the closed bottle.

Upon completion, and after the caretaker has taken the filled, closed bottle, the second front door 112 will be locked again. Only then the empty bottle base 132 automatically moves from section 3 118 back to section 1 114, where it will be ready to be reloaded with a new dirty bottle, to be inserted upside down. The movement of the core column 100, which causes the bottle base 132 to move from section 3 118 to section 1 114, is followed by the upper tray 130, which returns to the same position as it was in the beginning of the process.

When the bottle base 132 moves from section 3 118 to section 1 114, the bottle base 132 in section 2 115 moves to section 3 118 to allow the caretaker to receive another bottle on request. In parallel, the bottle base 132 and the bottle 124 from section 1 114 move to section 2 115. The upper tray 130 follows the movement of the core column 100 and keeps the components 121, 122, 123 of each bottle at approximately 60 degrees anticlockwise from the bottle body.

### Working Area Number 2: Upper Plate

The upper tray 130, as described before, is located above the fixed ceiling 137 of working area number 1 116. The tray 130 has three holes 140 and three areas between the holes 141, which has specific places for the bottle components. When the gripper has finished assembling the bottle cap 121, the nipple cap 122 and the nipple 123, it lays down the components on the upper tray 130 in the area between the holes 141. The tray 130 rotates with the core column 100, to allow the bottle components 121, 122, 123 to follow the bottle body 124. In addition, in order to allow the gripper to function, the upper tray 130 is free to rotate independently by approximately 60 degrees clockwise or anticlockwise, depending on the work being done.

### Water System

The water system is divided into two systems. The first system supplies the washing and sterilization chamber. The second system supplies the drinking water dispensing system. Both systems are fed from a main water container which stores tap water. A heater container is connected to the main water container. The supply of water from the main container to the heater container is controlled by an electric tap. An electric pump is connected to the heater container and a two way valve is connected to the electric pump. From there the water either flows to the washing system, or to the dispensing system, depending on the current requirements. The main container has minimum and maximum level indicators, which inform the caretaker when refilling is required. Container refill is done either by direct connection to the kitchen tap, or manually. The heater container has a maximum level indicator and a temperature indicator. The heater boils or heats water according to current needs.

The water system that supplies the drinking water will have a clean water container, which stores boiled water that has been cooled and reached room temperature. The clean water container has minimum and maximum level indicators. When the water level in the clean water container has fallen below the maximum level, the heater container boils water and stores it until it reaches room temperature. When this occurs, the pump passes water to the clean water container until the water level reaches the maximum level. Upon a request to dispense drinking water, an electric tap is opened and water flows out of the clean water tank, passes though a coiled spring which heats it to the desired temperature. A temperature sensor is placed after the coiled spring to control the water temperature.

The water system that supplies the cleaning and sterilizing process is also connected to the electric valve and will be pressurized with water upon request of cleaning and/or sterilizing. Upon request, the heating container heats the water to 80-90 degrees, which is then pumped into a mixing chamber, which is then pressurized with washing liquid. The washing liquid is mixed with the hot water in the mixing chamber and will continue to the nozzles in the washing chamber, i.e. section number 1 114 in working area number 1 116. Upon completion, clean hot water will continue to flow under pressure through the nozzles to wash all the washing liquid from the bottle body and its components. The sterilizing process will be by boiling water in the heating chamber and passing it through the nozzles in the cleaning chamber. Other possible sterilizing processes include the use of ultrasonic or ultraviolet radiation. A detailed description of the water system, and its related drawings, will be omitted from this application.

### Infant Formula and Additives System

The system for dispensing infant formula and additives is comprised of two doses containers. The first is the main container for infant formula and will be the bigger container, and the second container is for additives that the caretaker can optionally add to the bottle. The full description of the infant formula and additives system will be omitted from this application.

### DETAILED DESCRIPTION OF THE PREFERRED EMBODIMENT

Hereinafter, embodiments of a device for washing, sterilizing, dispensing liquid and infant formula into, and closing a baby bottle according to the present invention will be described in detail with reference to the accompanying drawings.

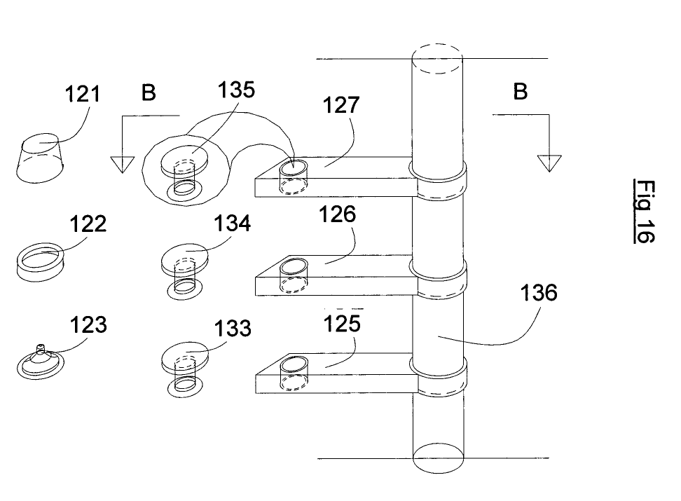

FIG. 1 is a perspective view showing an embodiment of the invention. FIG. 2 is a perspective view of FIG. 1, but with holes in the two front doors 111, 112 in working area 1 116, and the control board 143 in working area 2 117. The holes reveal the internal components of the invention, where in working area number 2 117 it is possible to identify the upper tray 130, the gripper 128 and telescopic arm 128 and the upper tray engine 144. In working area number 1 116 it is possible to identify the core column 100, sliding doors 120 and the bottle bases 132. FIG. 4 is a perspective view of the core column 100, internal column 101, bottle bases 132, connecting arms 131 (that connect the bottle bases 132 to the internal column 101) and the fixed plates 102. The position of the bottle body 124 is shown in each one of the sections, i.e. in the section 1 FIG. 2 114 the bottle body 124 is facing down and in sections 2 FIG. 2 115 and 3 FIG. 2 118 the bottle body 124 is facing up (open side is facing up). FIG. 4 is an embodiment of the core column, which has three fixed plates 102 (only two fixed plates can be seen in FIG. 4). The fixed plates 102 are affixed to the core column 100. Each couple of connecting arms 131 form an angle of 120 degrees between them and each connecting arm can rotate freely around its axis. The connecting arm 131 is connected to the bottle bases 132 and rotates twice by 180 degrees during one cycle, the first time during the transition between section 1 114 and section 2 115, and the second time during the transition between section 3 118 and section 1 114. In addition three etchings 103 can be seen in the core column 100 FIG. 15. Each couple of etchings 103 in the core column form an angle of 120 degrees, in order to let the two plastic edges 108 of the sliding doors 120 fit inside the core column etchings 103 when the sliding doors 120 are closed FIGS. 15 and 19, thereby sealing section number 1 114 from both sides. Another element shown in FIG. 4 is the bottle base weight 104 next to the bottle base 132, whose role is to displace the center of gravity of the base. This displaced center of gravity causes the bottle base 132 to rotate 180 degrees during the movement from section 1 114 to 2 115.

FIG. 4a is a perspective view of cut G-G in FIG. 4. The cut is from the edges of the internal column 101 through section 1 114 and 3 118, i.e. the center of the fixed plates 102, connecting arms 131, the bottles bases 132 and the bottles 124. From cut G-G it is possible to identify the internal column etching 105.

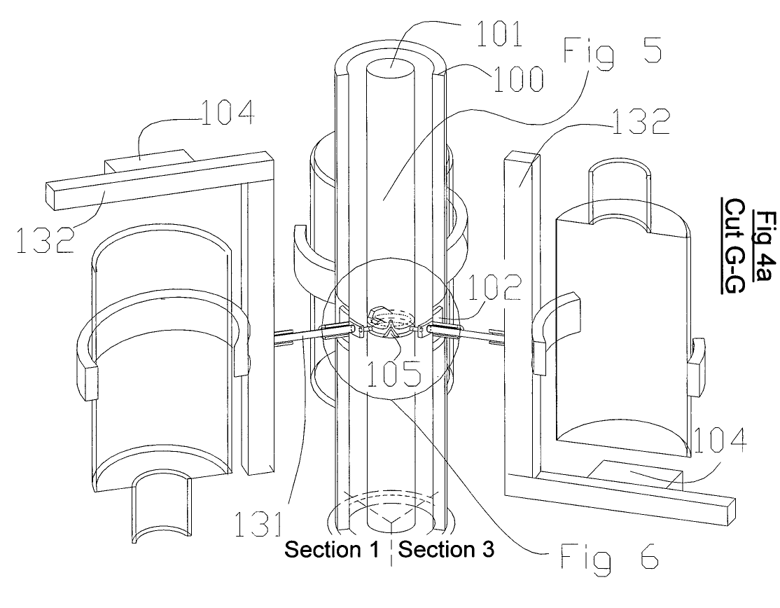

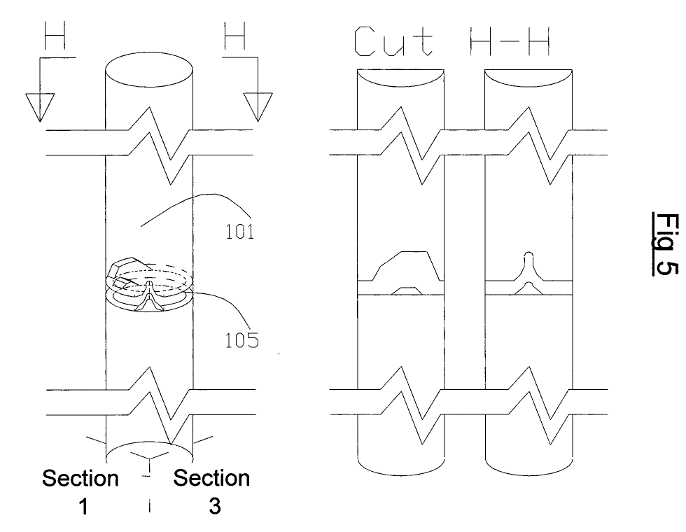

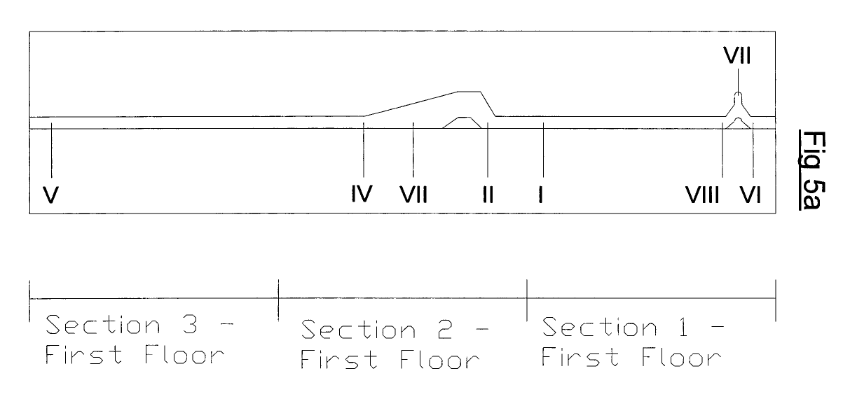

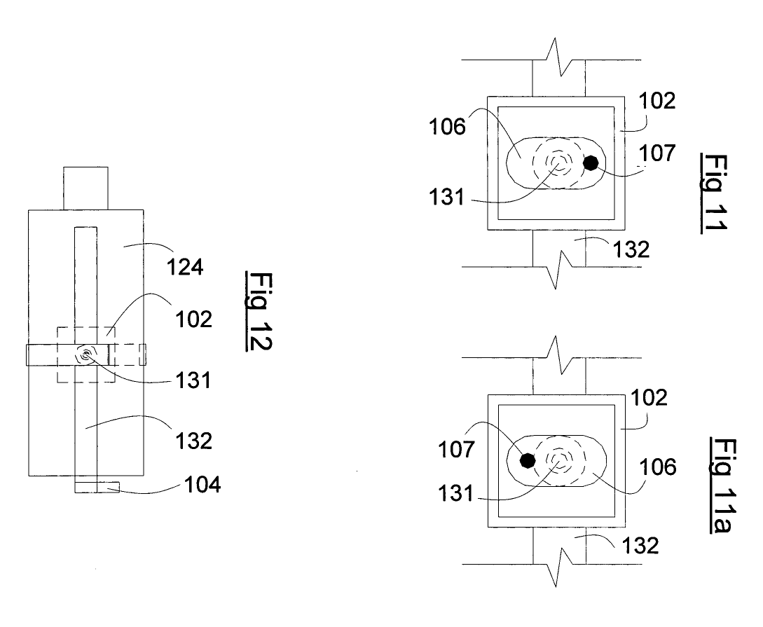

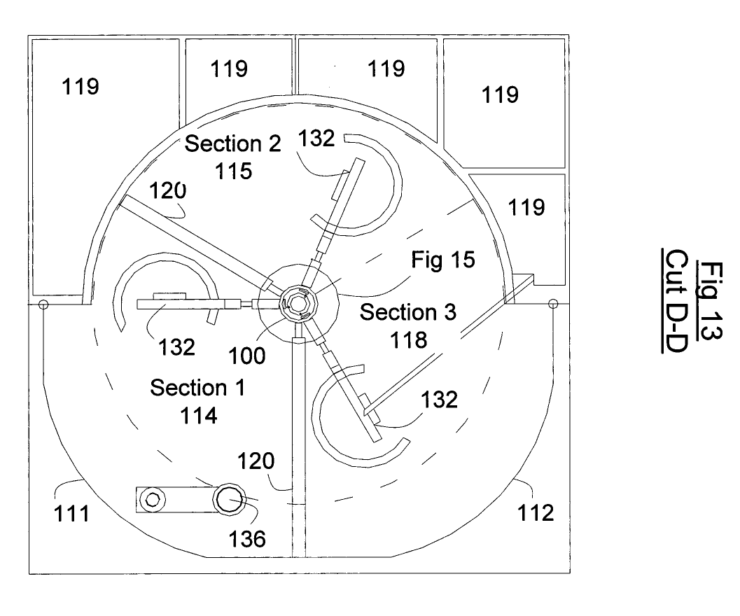

FIG. 6 is a perspective view of the internal column etching 105 and the location of the connecting arms 131 from section 1 114 and 3 118 relative to the internal column 101. The connecting arms 131 are attached to the connecting arm plate 106 in the center of the plate, while on the other side of the plate 106 there is a pin 107, which is attached on one of its sides to the plate 106 and on the other side the pin runs in the internal column etching 105. FIG. 11 is a plan view from the internal column 101 outside, where the pin 107, which is attached to the plate 106 on one of its sides, and the location of the connecting arm 131 in the center of the plate 106, are shown. It can be seen that plate 106 can turn around in the internal side of the fixed plate 102, which is fixed to the core column 100. The other side of the pin 107 runs in the internal column etching 105 FIG. 6 and causes the connecting arm plate 106 to rotate according to the shape of the internal column etching 105. The connecting 131 arm rotates together with the plate 106 and causes the bottle base 132 to rotate with it, which causes the bottle 124 to turn around.

FIG. 5 is a perspective view of the internal column 101 and its etching 105. Also shown in FIG. 5 a cut H-H that shows the two halves of the internal column 101 and the shape and location of the etchings 105 in each one of the halves. FIG. 5a is a sliced plain view of the etching 105 in the internal column 101 with reference to the three sections 114, 115, 118 in working area number 1.

Before describing the location of the connecting arm pin 107 in the internal column etching 105, in each one of the sections 114, 115, 118, note that the internal column 101 is fixed and not moving, while the core column 100 is the one that rotates around its center, the rotation being clockwise only. In addition, the explanation of how the bottle base rotates by 180 degrees in two different locations will be given for one bottle base 132 only.

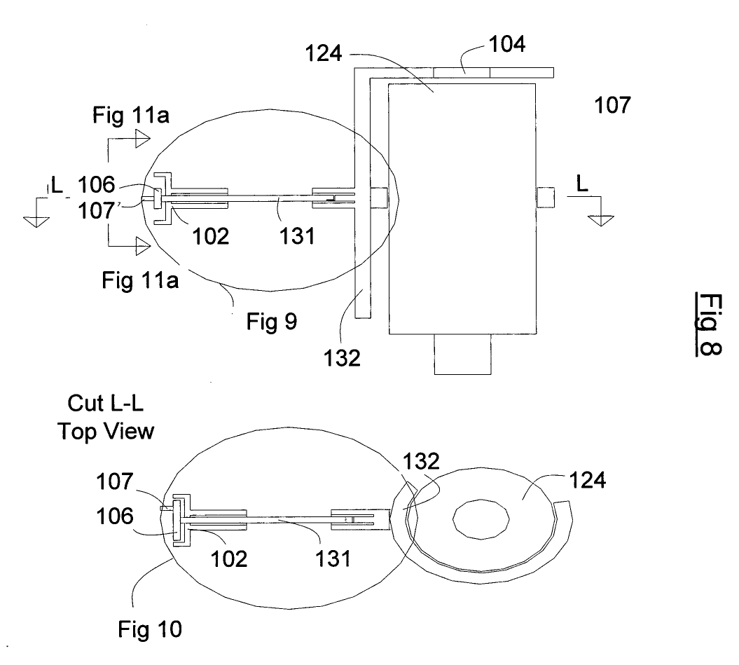

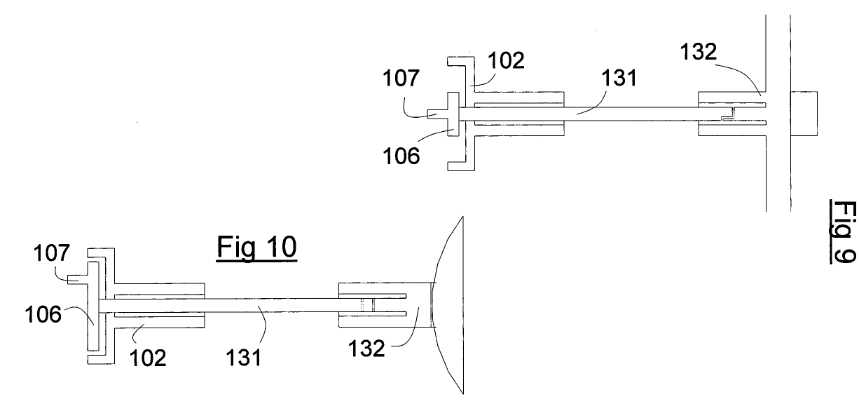

The explanation of the movement of the pin 107 with reference to the etching 105 in the internal column 101, will be done using FIGS. 4, 5, 5a, 6, 7, 8, 9, 10, 11, 11a. In addition, the explanation will be with reference to the latin numbering appearing in FIG. 5a. Even though the latin numbering appears only in FIG. 5a, it is relevant to the rest of the figures.

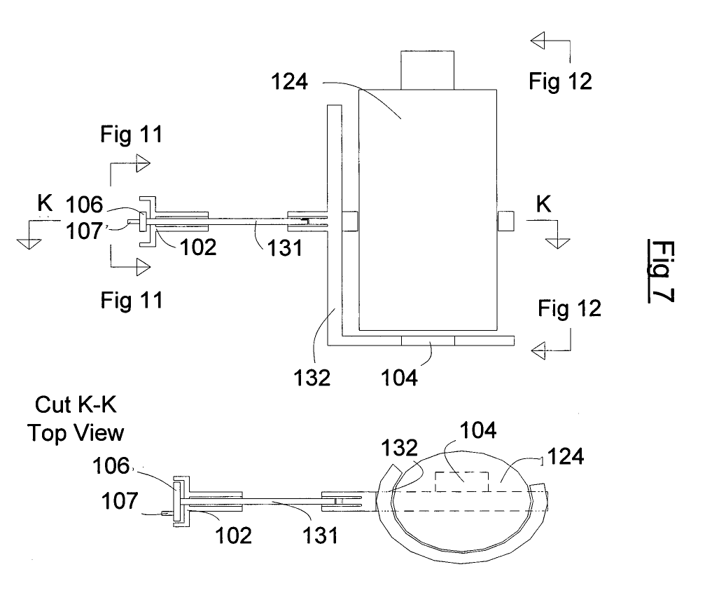

When the caretaker inserts a dirty bottle 124, it is positioned in section 1 114 at point number I FIG. 5a. The position of the bottle base 132 forces the caretaker to fit a bottle body 124 with its open side facing down FIGS. 4 and 8. The location of the pin 107, relative to the connecting arm plate 106, is as shown in FIGS. 6 and 11a, 8, 9, 10, i.e. the pin 107 is at the back side of the plate 106 FIG. 8 Top view and FIG. 11a. The other side of the pin 107 is located inside the internal column etching 105, at point number I in FIG. 5a. The bottle base weight 104 FIGS. 4 and 8, tends to pull the bottle base 132 downwards, but due to the fact that the pin 107 is inside the internal column etching 105 and being bound by the top side of the etching, no movement can take place.

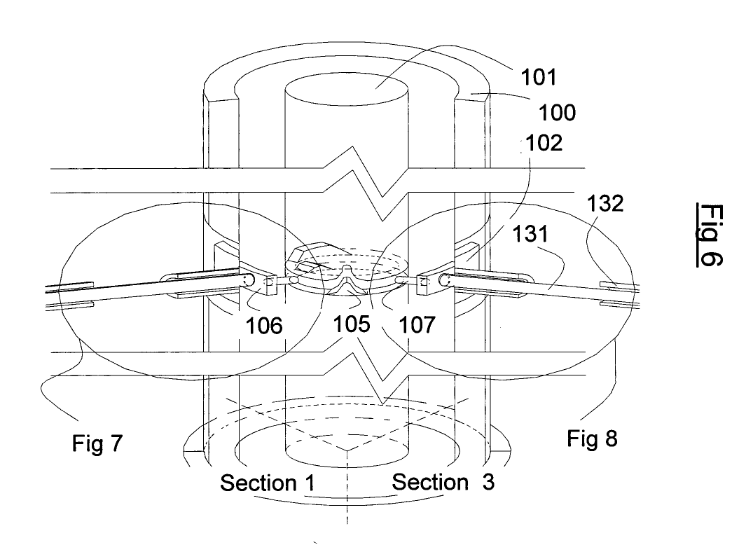

After all the processes in section 1 114 are finished, and in case where in section 3 118 there is an empty base 132, the core column 100 rotates 120 degrees clockwise. When the pin 107 reaches point number II FIG. 5a, the etching 105 widens, allowing the pin 107 to move freely upwards. Thus, the bottle base weight 104 can now pull the bottle base 132 downwards from a position where the open side of the bottle is facing down FIG. 8, to a position where the open side of the bottle 124 is facing up FIG. 7. As a consequence of this movement, the connecting arm 131, together with the plate 106 and the pin 107, rotate 180 degrees (which is the first rotation of 180 degrees). This causes the bottle base 132 to reach to point III FIG. 5a, in a position shown in FIG. 7, i.e. the open side of the bottle body 124 is facing up and the pin 107 has changed its location from the back side of the plate 106 FIG. 8 Top view and FIG. 11a to a position where it is in the front of the plate 106 FIG. 7 Top view and FIG. 11. The core column 100 then stops its 120 degrees rotation in a position where the bottle base is located at point number IV FIG. 5a, which is in section number 2 115. In this position the pin 107 is again bound by the top and bottom of the internal column etching 105. The movement of the bottle base from section 2 115, point IV FIG. 5a, to section 3 118, point V FIG. 5a, is by another movement, of 120 degrees clockwise, of the core column 100. i.e. the bottle body 124 open side still facing up, the pin 107 is located as described in FIGS. 7 and 11. After the caretaker has taken the bottle body 124 and its components from section 3 118, and after closing the right front door 112, the core column 100 automatically rotates another 120 degrees clockwise. During the movement the bottle base 132 the connecting arm 131 the plate 106 and the pin 107 move as well. When the pin 107 reaches point VI FIG. 5a, and due to the fact that it is the core column 100 that causes the movement, the pin 107 is forced up the slope until reaching point VII. During this movement, the core column 100 continues to rotate, causing the pin 107 to reach point VIII FIG. 5a when it is at the back side of the plate 106, i.e. at point VI FIG. 5a the bottle body 124, the bottle base 132, and the pin 107 are as shown in FIGS. 7 and 11, while at point VIII the bottle base 132 and the pin 107 are as shown in FIG. 8 and 11a. i.e. the bottle base 132 is rotating by 180 degrees for the second time.

After the second movement of 180 degrees the bottle base 132 reaches section 1 114 in its original position, i.e. allowing the caretaker to reload another bottle body 124, with its open side facing down.

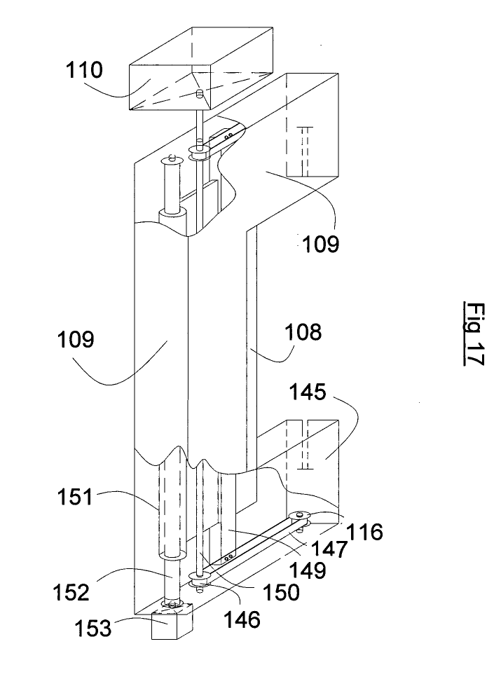

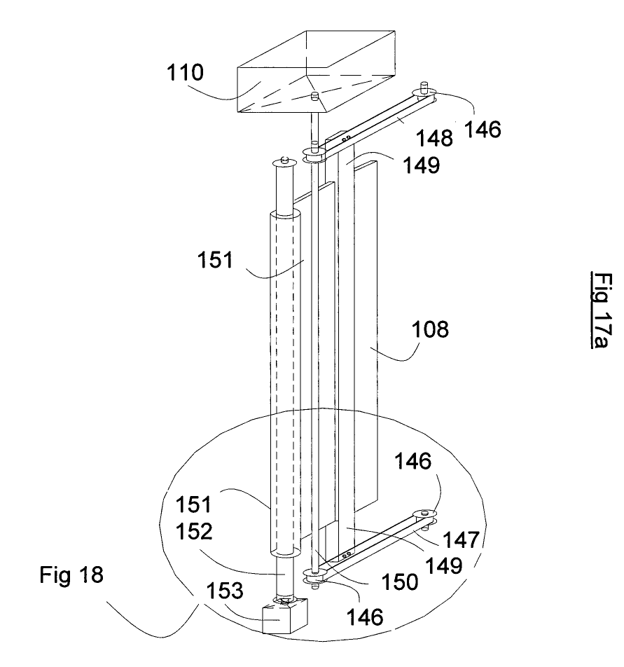

FIG. 17 is a perspective view of one of the two sliding doors 120 that are located on both sides of section 1 114, in working area number 1 116. FIG. 17a is a perspective view of FIG. 17, but without the external cover 109 of the sliding door 120. FIG. 18 is a perspective view of the bottom of the internal parts of the sliding door 120.

When the caretaker has put the bottle body and its components in their allocated places in section 1 114, the washing and sterilizing process begins. The sliding door's engine 110 turns the wheel's column 150 that turns the wheels 146 and the belts 147 and 148. The leading column 149, which is connected to the top belt 148 and bottom belt 147, moves with the belts. The leading column 149 is connected on one side to a curtain 151 and on the other side to a plastic edge 108. The movement of the leading column 149 pulls the curtain 151 and pushes the plastic edge 108 until the plastic edge 108 slides inside the core column etching 103. When the plastic edge 108 slides in the core column etching 103 it prevents water or moisture from crossing the gap between the sliding door 120 and the core column 100. In addition, a spring 153 connected to the curtain column 152 tightly seals the curtain 151 at all times. At the end of the processes in section 1 114, both curtains 151 open. The sliding doors 120 open, as before, by a movement of the engine 110, the wheels 146 and the top and bottom belts 147 and 148. When the opening process begins, the leading column 149 is pulled back, together with the plastic edge 108 and the curtain 151. During the backward movement of the leading column the spring 153, which is connected to the curtain column 152, pulls the curtain 151 to its original position, i.e. around the curtain column 152. In addition, the plastic edge 108 is pulled back, allowing the bottle bases 132 to move through the gap in the sliding doors 120. This gap is wide enough to allow the bottle body 124 and its base 132 to pass through.

The movement of the sliding doors 120 seals section 1 114 on both sides during the washing and sterilization process. FIG. 19 is a side view of the sliding door 120 in a closed and open position. When closed, the plastic edge 108 is in front of the sliding door internal edge 145. When open, the sliding door 120 has an open gap, through which the bottle 124 and its base 132 will pass.

FIG. 20 is a top view through cut A-A, FIG. 19. The position of each one of the components in the open and closed position is shown.

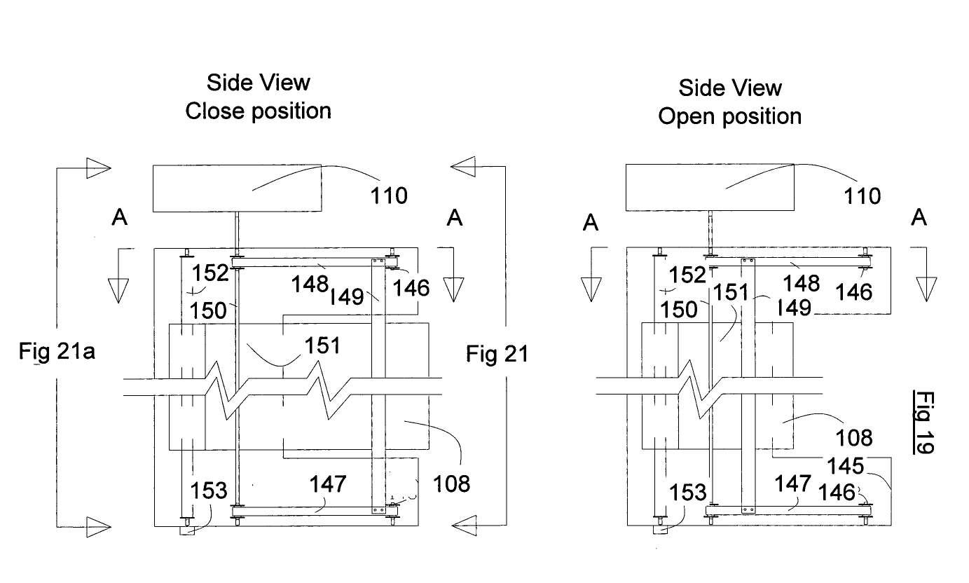

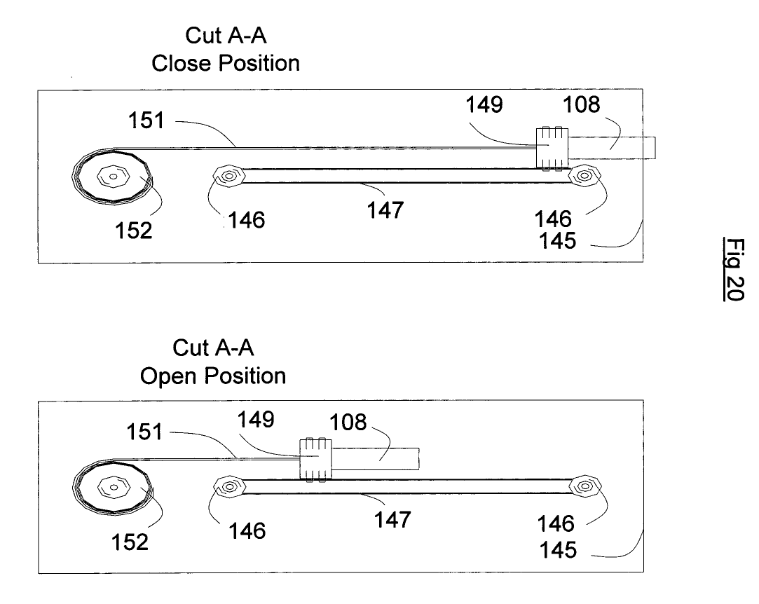

FIGS. 21 and 21a are an inside-out view and an outside-in view, respectively, of the sliding door 120. In FIG. 21 the engine 110, the top and bottom wheel 146, the leading column 149, and the plastic edge 108 are shown.

In FIG. 21a the curtain 151, the curtain column 152, the engine 110 and the spring 153 are shown.

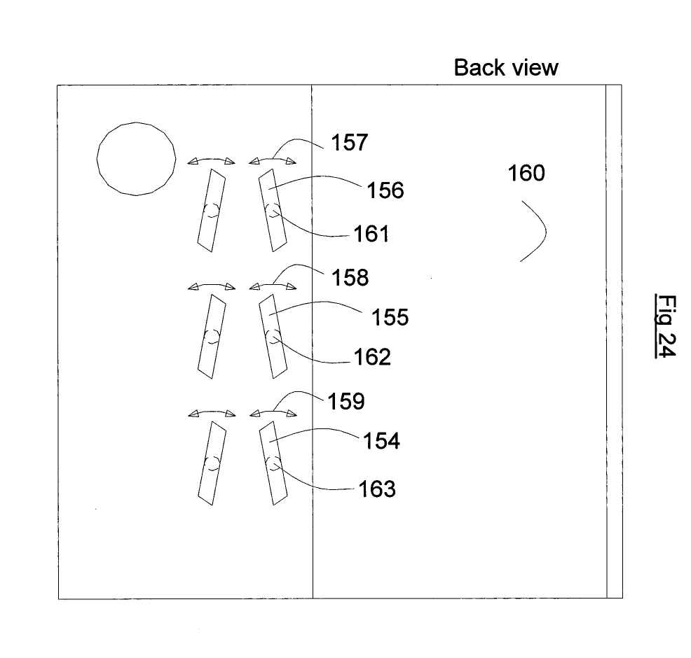

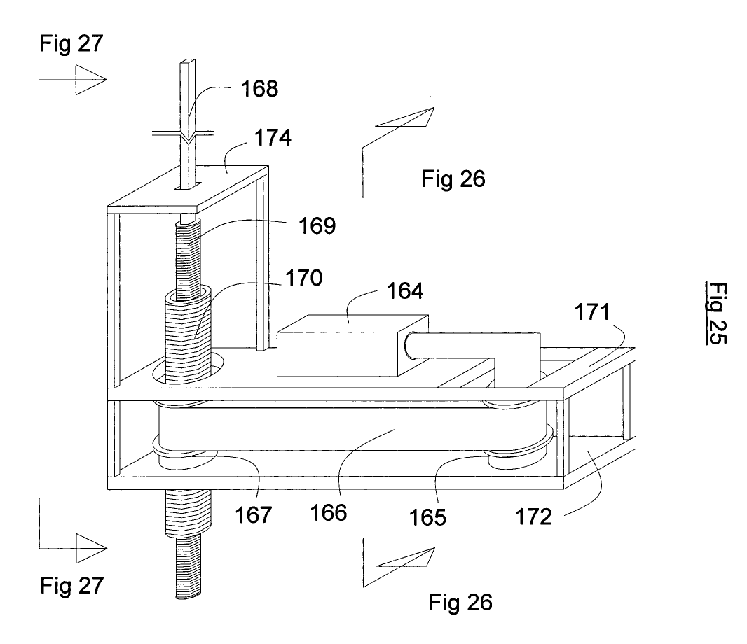

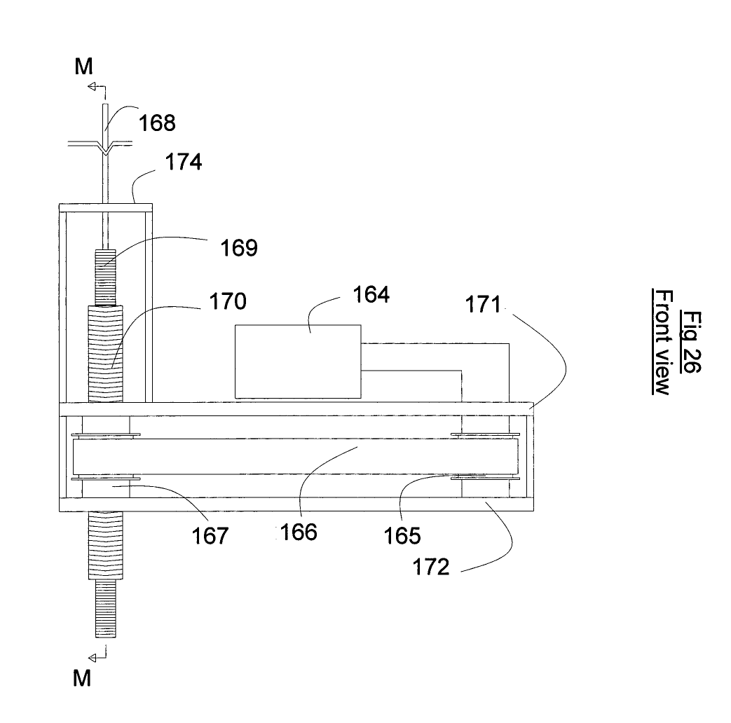

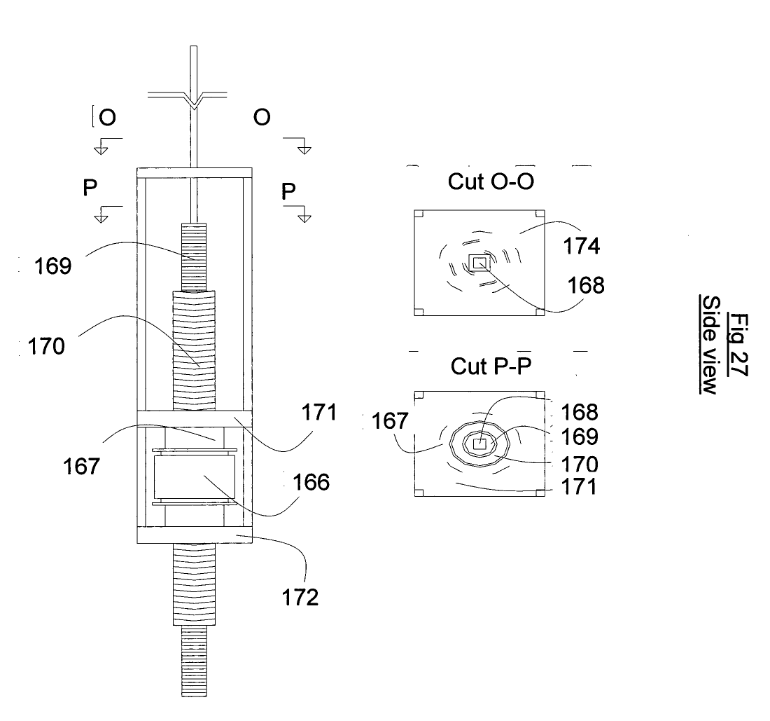

FIG. 25 is a perspective view of the telescopic arm 128 mechanism. FIG. 26 is a front plan view of the telescopic arm 128 mechanism. FIG. 27 is a plan side view of the telescopic arm mechanism. FIG. 28 represents Cut M-M in FIG. 26.

With reference to FIGS. 25, 26, 27 and 28. When an order has been given to move the gripper 128 downward (or upward), the telescopic arm engine 164 FIG. 25 rotates the right wheel 165, which then transfers the movement through the belt 166 to the left wheel 167.

The extended arm is built of four parts: a square bar 168, an internal screw 169, a middle screw 170 and the left wheel 167. The square bar 168, which passes through the top plate 174 square hole, is attached to the top side of the internal screw 169 and does not rotate clockwise or anticlockwise, but allows the square bar 168 and the internal screw 169 to move upward or downward.

The internal screw 169 passes through the middle screw 170, which has internal etchings that fit the internal screw. The internal part of the left wheel 167 also has etchings that fit the external side of the middle screw 170.

When the left wheel turns 167, the movement is transferred to the middle screw 170, which in turn transfers the movement to the internal screw 169. Because the internal screw is attached to the square bar 168, which does not rotate but allows vertical movement, the rotation force is transferred to vertical movement.

When the left wheel 167 starts rotating, the middle screw 170 and the internal screw 169 start moving downward, until reaching a position where the top side of the middle screw 170 reaches the top side of the middle plate 171. The middle screw 170 cannot continue downward, and the vertical movement is carried out by the internal screw 169 only. The internal screw 169 moves downward until its top part reaches the bottom of the middle screw 170. The same mechanism applies for upward vertical movement, but in this case the bottom part of the middle screw 170 reaches the bottom plate 172, and then starts to rotate together with the right wheel 167. This causes the rotation movement to pass through to the internal screw 169, which will continue moving upward until its bottom part will reach the bottom part of the middle screw 170.

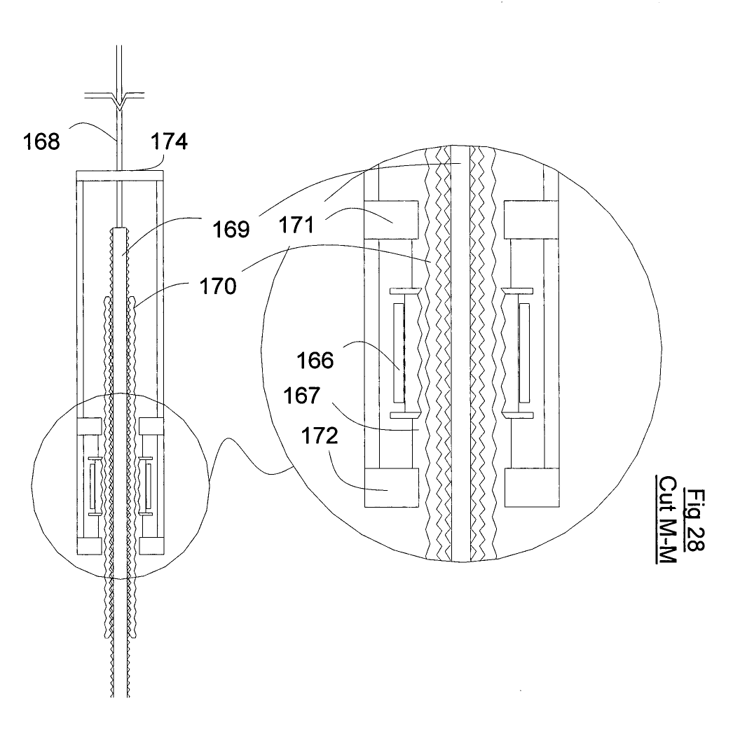

Owing to the square bar 168, the internal screw 169 will only move upward or downward (i.e. vertical movement only). On the contrary, the middle screw 170 will move downward or upward, until it reaches a position where it can't continue its vertical movement, and will start rotating with the right wheel 167, allowing movement to pass through to the internal screw 169, and allowing it to continue in its vertical movement. The bottom part of the internal screw 169 is connected to the top side of the gripper engine FIG. 29 173.

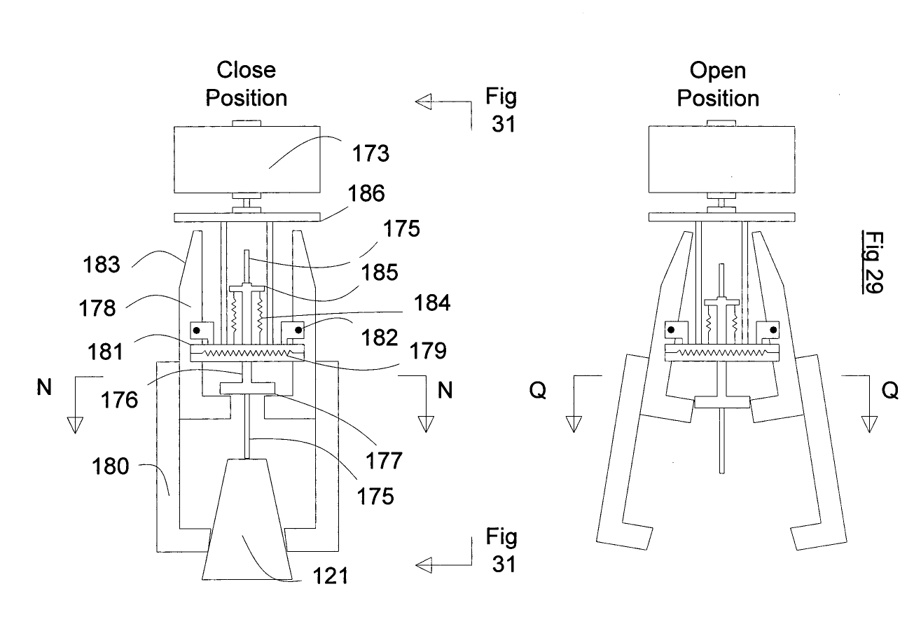

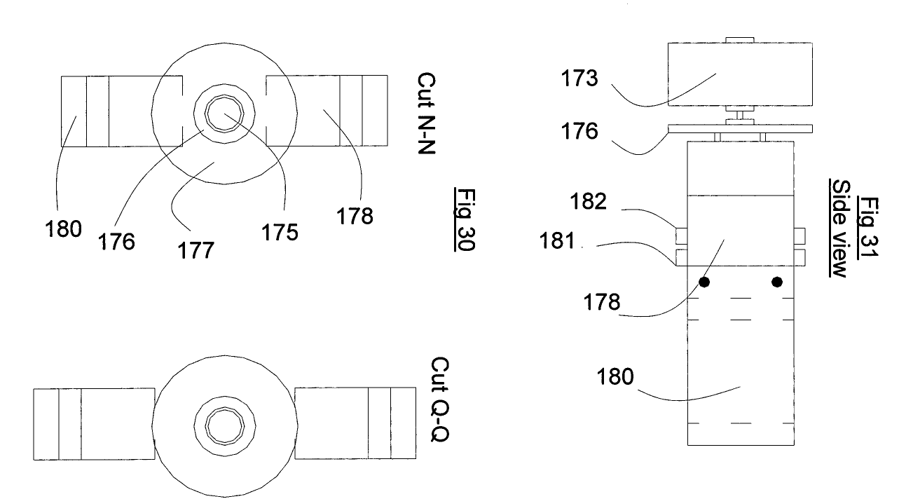

FIG. 29 is a plan view of the gripper 129 in two positions: closed and open. FIG. 30 is a top plan view of cut N-N and Q-Q, FIG. 29. FIG. 31 is a side view of the gripper 129 in the closed position (FIG. 29).

With reference to FIGS. 29, 30, and 31. The gripper is lowered down by the telescopic arm 128 when it is in an open position (FIG. 29 open position). When the gripper 129 is lowered on the bottle cap 121, the top of the bottle cap presses the internal bar 175, which pushes the stopper 176 upward until the bottom part of the stopper bottom plate 177 is above the bottom of the gripper top arms 178 (FIG. 29 closed position). As a consequence the main spring 179 pulls both top arms 178, allowing the gripper bottom arms 180 to grab the bottle cap 121.

In order to enable the movement, the gripper bottom arms 180 are attached to the gripper top arms 178, which are attached to the middle plate 181 via hinges 182. The hinges 182, as shown in FIG. 29, are located above the main spring 179, to allow the main spring 179 to pull the top arms 178 efficiently.

In order to open the gripper 129, the caretaker presses both sloped areas 183 on the top sides of the gripper top arms 178. This stretches the main spring 179, allowing the top springs 184 to push the stopper top plate 185 downward. This causes the stopper bottom plate 177 to move downward (from its closed position to its open position in FIG. 29). By doing so, the bottom part of the gripper top arms 178 are stopped by the stopper bottom plate 177, allowing the bottle cap 121 to be released and leaving the gripper 129 in an open position.

The gripper top plate 186 is attached at the bottom to the gripper middle plate 181 and at the top to the gripper engine 173. The gripper engine rotates clockwise, transmitting the clockwise rotation to the gripper 129, in order to close the bottle components on the bottle body 124 after it has been filled with the required amount of water and infant formula and optional additives. Before the caretaker takes the closed bottle he must press the sloped areas 183 on the top arms 178 in order to release the bottle cap 121 from the gripper.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modification and changes will readily occur to those skilled in the art, it is not desired to limit the invention to the exact construction and operation shown and described, and accordingly, all suitable modifications and equivalents may be resorted to, falling within the scope of the invention.

1-9. (canceled)

10. A device for performing at least one of preselected operations on a baby bottle and associated components for use in feeding infants, said device comprising:
a carousel-shaped platform disposed within a housing and having an integrally formed, centrally located core column rotatably disposed about a fixed internal column, said platform accommodating said associated components;
a bottle-gripping means removably attached to and extending from said core column, said bottle-gripping means accommodating a baby bottle;
an inversion means to invert said baby bottle 180° in a vertical plane prior to performing said at least one of preselected operations;
a dispensing means disposed in an upper portion of said housing for dispensing measured amounts of heated water, infant formula, and other optional ingredients; and
a control board for operating said device and setting working parameters for said preselected operations,
such that when said device is connected to a power source and operated using said control board to set said working parameters,
said platform and said associated components disposed therein rotate together with said core column around said fixed internal column in a horizontal plane between at least two predefined sectors of said housing associated with at least two of said selected operations,
said bottle-gripping means provides support to said baby bottle prior to performing said at least one of said preselected operations within at least one of said two
predefined sectors, while said inversion means simultaneously inverts said baby bottle 180 degrees at least once in a cycle of said preselected operations during rotation of said platform and core column around said fixed internal column, and
said dispensing means dispenses said measured amounts of heated water, infant formula, and other optional ingredients to prepare said baby bottle.

11. The device of claim 10 arranged for processing a plurality of baby bottles.

12. The device of claim 10, wherein said associated components form a set for closing and sealing a baby bottle, said set comprising: a nipple, a nipple cover, and a baby bottle cover.

13. The device of claim 10, wherein said inversion means comprises small grooves formed on said fixed internal column.

14. The device of claim 13, wherein said small grooves are adjustable to match the physical requirements of accommodating and processing more than one baby bottle and their associated components at one time within said housing, said processing being the performance of at least one of said preselected operations.

15. The device of claim 10, further comprising:
a carousel floor provided with orifices for draining water from said carousel platform; and
a carousel ceiling provided with at least two orifices alignable with the predetermined position of an opening in said baby bottle when deployed in one of said at least two predefined sectors and oriented in an upright position by said inversion means prior to at least one of said preselected operations,
such that said baby bottle is filled directly from said dispensing means through at least one of said at least two orifices.

16. The device of claim 10, wherein said housing is constructed so as to provide water proof seals to maintain a separation between one of said at least two predefined sectors designated as a wet sector, and another designated as a dry sector for respective wet and dry operations, and including a waiting area provided therebetween when more than one baby bottle is being processed in said device at the same time.

17. The device of claim 10, wherein said bottle-gripping means are replaceable to provide a match to any given size baby bottle inserted into said device.

18. The device of claim 10, wherein said dispensing means comprises a combination of a liquid dispenser connected to a hot water source for providing doses of heated water and a refillable dry ingredients dispenser for providing measured amounts of infant formula and other optional ingredients for filling said baby bottle.

19. The device of claim 18, wherein said hot water source comprises a monitored water-saving heating system.

20. The device of claim 19, wherein said monitored water-saving heating system comprises:
a water heating tank and a first water pump for beating water and delivering it to said system;
a small holding tank having at least one water pump and a radiator operable in a closed fluid loop with each other, and having an inlet connected by valve to said water heating tank for receiving heated water and an outlet connected by valve to said dispenser means; and
a T-joint having an inlet connected to an outlet of said first water pump, with one T-joint valve-controlled outlet connected to a water dispersal means disposed in said housing, and a second T-joint valve-controlled outlet connected to said small holding tank,
such that when said device is operated, water in said heating tank is heated and pumped by said first pump to said T-joint, and when one T-joint valve-controlled outlet connected to said dispersal means is opened, water is pumped by said first water pump at full heated temperature through said dispersal means for optimum cleaning and sterilizing operations; and
when said T-joint is opened in the direction of said second valve-controlled outlet to said small holding tank, heated water is directed into said small holding tank for rapid cooling by closed circulation in conjunction with said radiator and thereafter pumped by said at least one water pump for monitored release to said baby bottle.

21. The device of claim 20, wherein said dispersal means comprises a plurality of high pressure, hot water nozzles so arranged within said housing as to optimize washing and sterilizing of said baby bottle and associated components.

22. The device of claim 21, wherein said sterilizing is implemented by at least one of a UV and an ultrasound radiation device incorporated into said housing.

23. The device of claim 10, further comprising:
a washing column provided with mechanical washing arms for manipulation of said baby bottle and associated components during said washing and sterilizing operations; and
a telescopic arm for retrieving said associated components in one of said preselected operations.

24. The device of claim 10, wherein said cycle of preselected operations comprises at least one of the following operations:
washing and sterilizing said baby bottle and associated components;
filling said baby bottle with measured amounts of heated water and infant formula and other predetermined ingredients;
assembling and readying said associated components to return to said baby bottle; and
closing and sealing said baby bottle.

25. The device of claim 10, wherein said working parameters are selected from at least one of the following:
washing temperature and time of washing;
temperature of dispensed water;
measured amounts of water and/or infant formula and/or said other predetermined ingredients to be poured into said bottle body; and
time for overall processing and/or for timing a subset of individual parameters and any combinations thereof.

26. The device of claim 10, wherein said housing is constructed so as to provide seals to maintain a separation between one portion of work space designated for said washing and sterilizing operations, and another portion of work space designated for filling, closing and bottle-sealing operations.

27. A method for preparing a baby bottle and associated components for use in feeding infants, said method comprising:
providing a device for performing at least one preselected operation on said baby bottle and associated components disposed within a sealable housing, said at least one preselected operation selected from the group of operations including: washing, sterilizing, filling, :losing and sealing;
providing a control board connectable to a power source for operating said baby bottle device;
setting working parameters on said control board for at least one of said preselected operations;
inserting a baby bottle and associated components into said housing having a plurality of bottle-gripping means disposed therein and attached to a core column for seating said baby bottle for processing;
inverting said baby bottle 180° at least once prior to performing at least one of said preselected operations;
washing and sterilizing said baby bottle and associated components;
uprighting said baby bottle 180° ready for filling;
filling said baby bottle with measured amounts of heated water and infant formula and other predetermined ingredients from a dispensing means;
assembling one set of said associated components for each baby bottle; and
closing and sealing said baby bottle after filling, utilizing said assembled sets of associated components,
such that when said control board of said preparatory device is connected to a power source and operated, said baby bottle and associated components placed separately therein are washed and sterilized, said baby bottle is filled with predetermined amounts of heated water and infant formula, and subsequently, said associated components are assembled and returned to close and seal said baby bottle making it ready for use.

28. The method of claim 27, adapted for a plurality of baby bottles processed in said device wherein said associated components form sets assembled for closing and sealing each of said baby bottles, each of said sets comprising: a nipple, a nipple cover, and a baby bottle cover.

29. The method of claim 27, wherein said working parameters are selected from at least one of the following:
washing temperature and time of washing;
temperature of dispensed water;
measured amounts of water and/or infant formula and/or said other predetermined
ingredients to be poured into said bottle body; and
time for overall processing and/or for timing a subset of individual parameters and any combinations thereof.
